(19) United States
(12) Patent Application Publication
(10) Pub. No.: US 2019/0266497 A1
(43) Pub. Date: Aug. 29, 2019

(54) KNOWLEDGE-GRAPH-DRIVEN RECOMMENDATION OF CAREER PATH TRANSITIONS

(71) Applicant: Microsoft Technology Licensing, LLC, Redmond, WA (US)

(72) Inventors: Yiping Yuan, Sunnyvale, CA (US); Baolei Li, Santa Clara, CA (US); Romer E. Rosales-Delmoral, Burlingame, CA (US)

(73) Assignee: Microsoft Technology Licensing, LLC, Redmond, WA (US)

(21) Appl. No.: 15/904,193

(22) Filed: Feb. 23, 2018

(51) Int. Cl. G06N 5/02; G06F 17/30; G06Q 50/00

(52) U.S. Cl. CPC G06N 5/025; G06Q 50/01; G06F 17/30867

(57) ABSTRACT

The disclosed embodiments provide a system for processing data. During operation, the system obtains a knowledge graph containing a set of job transitions for members of an online network. Next, the system receives a career path query for a member of the online network. The system then uses member features for the member and parameters of the career path query to identify one or more paths in the knowledge graph that match the career path query. Finally, the system outputs the one or more paths in a result of the career path query

### BACKGROUND

### Field

The disclosed embodiments relate to user recommendations. More specifically, the disclosed embodiments relate to techniques for performing knowledge-graph-driven recommendation of career path transitions.

### Related Art

Online networks may include nodes representing entities such as individuals and/or organizations, along with links between pairs of nodes that represent different types and/or levels of social familiarity between the entities represented by the nodes. For example, two nodes in an online network may be connected as friends, acquaintances, family members, and/or professional contacts. Online networks may further be tracked and/or maintained on web-based networking services, such as online professional networks that allow the entities to establish and maintain professional connections, list work and community experience, endorse and/or recommend one another, run advertising and marketing campaigns, promote products and/or services, and/or search and apply for jobs.

In turn, users and/or data in online professional networks may facilitate other types of activities and operations. For example, sales professionals may use an online professional network to locate prospects, maintain a professional image, establish and maintain relationships, and/or engage with other individuals and organizations. Similarly, recruiters may use the online professional network to search for candidates for job opportunities and/or open positions. At the same time, job seekers may use the online professional network to enhance their professional reputations, conduct job searches, reach out to connections for job opportunities, and apply to job listings. Consequently, use of online professional networks may be increased by improving the data and features that can be accessed through the online professional networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows the use of a knowledge graph to process a career path query in accordance with the disclosed embodiments.

FIG. 4 shows a flowchart illustrating the processing of data in accordance with the disclosed embodiments.

FIG. 5 shows a flowchart illustrating a process of generating a result of a career path query in accordance with the disclosed embodiments.

FIG. 6 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

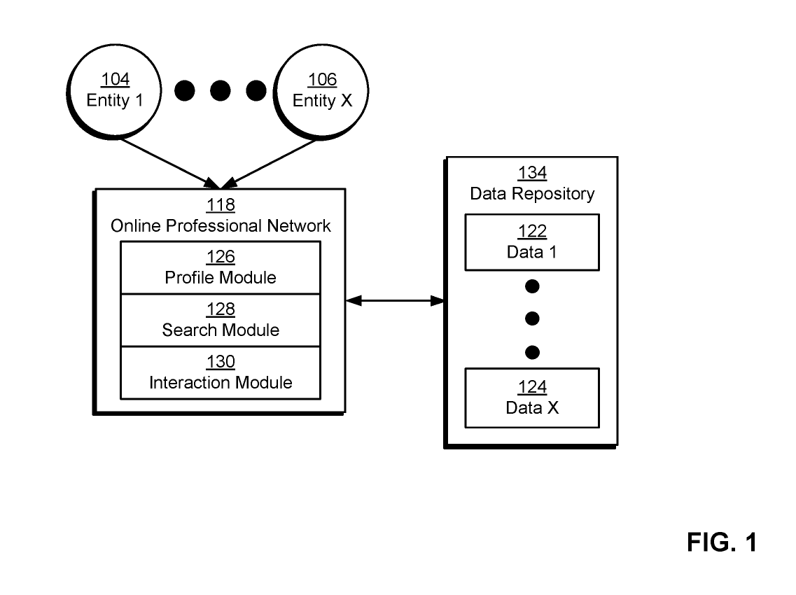

The disclosed embodiments provide a method, apparatus, and system for processing data. As shown in FIG. 1, the data may be associated with a user community, such as an online professional network 118 that is used by a set of entities (e.g., entity 1 104, entity x 106) to interact with one another in a professional and/or business context.

The entities may include users that use online professional network 118 to establish and maintain professional connections, list work and community experience, endorse and/or recommend one another, search and apply for jobs, and/or perform other actions. The entities may also include companies, employers, and/or recruiters that use online professional network 118 to list jobs, search for potential candidates, provide business-related updates to users, advertise, and/or take other action.

More specifically, online professional network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online professional network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online professional network 118 also includes a search module 128 that allows the entities to search online professional network 118 for people, companies, jobs, and/or other job- or business-related information. For example, the entities may input one or more keywords into a search bar to find profiles, job postings, articles, and/or other information that includes and/or otherwise matches the keyword(s). The entities may additionally use an “Advanced Search” feature in online professional network 118 to search for profiles, jobs, and/or information by categories such as first name, last name, title, company, school, location, interests, relationship, skills, industry, groups, salary, experience level, etc.

Online professional network 118 further includes an interaction module 130 that allows the entities to interact with one another on online professional network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online professional network 118 may include other components and/or modules. For example, online professional network 118 may include a homepage, landing page, and/or content feed that provides the latest posts, articles, and/or updates from the entities' connections and/or groups to the entities. Similarly, online professional network 118 may include features or mechanisms for recommending connections, job postings, articles, and/or groups to the entities.

In one or more embodiments, data (e.g., data 1 122, data x 124) related to the entities' profiles and activities on online professional network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online professional network 118 may be tracked and stored in a database, data warehouse, cloud storage, and/or other data-storage mechanism providing data repository 134.

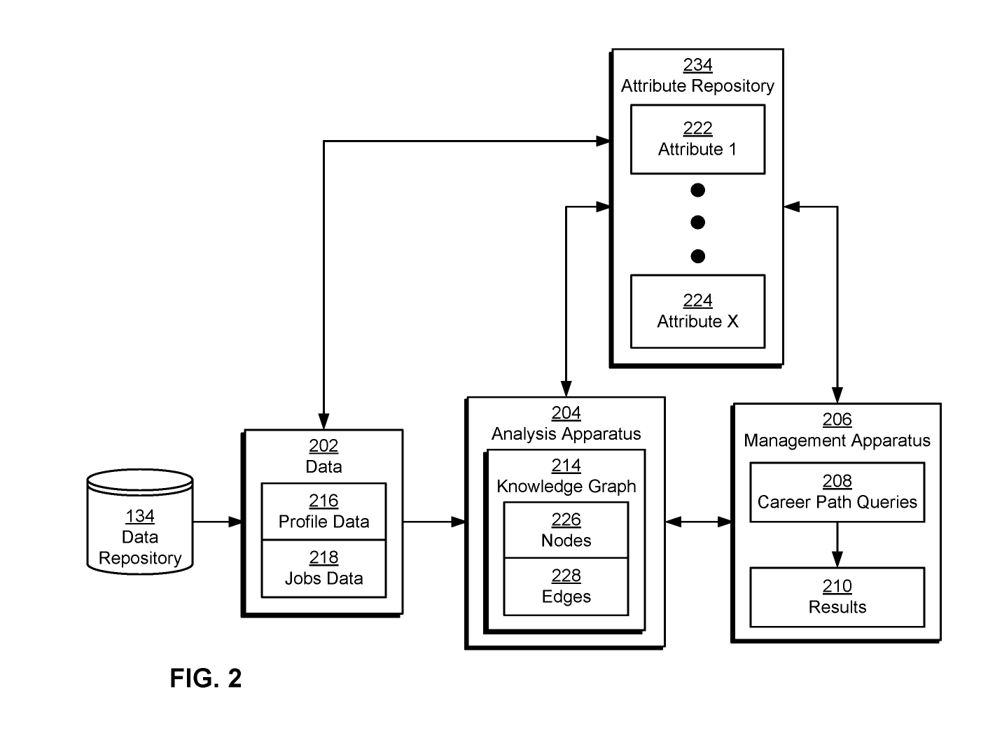

As shown in FIG. 2, data repository 134 and/or another primary data store may be queried for data 202 that includes profile data 216 for members of a social network (e.g., online professional network 118 of FIG. 1), as well as jobs data 218 for jobs that are listed or described within or outside the social network. Profile data 216 includes data associated with member profiles in the social network. For example, profile data 216 for an online professional network may include a set of attributes for each user, such as demographic (e.g., gender, age range, nationality, location, language), professional (e.g., job title, professional summary, employer, industry, experience, skills, seniority level, professional endorsements), social (e.g., organizations of which the user is a member, geographic area of residence), and/or educational (e.g., degree, university attended, certifications, publications) attributes. Profile data 216 may also include a set of groups to which the user belongs, the user's contacts and/or connections, and/or other data related to the user's interaction with the social network.

Attributes of the members from profile data 216 may be matched to a number of member segments, with each member segment containing a group of members that share one or more common attributes. For example, member segments in the social network may be defined to include members with the same industry, title, location, and/or language.

Connection information in profile data 216 may additionally be combined into a graph, with nodes in the graph representing entities (e.g., users, schools, companies, locations, etc.) in the social network. In turn, edges between the nodes in the graph may represent relationships between the corresponding entities, such as connections between pairs of members, education of members at schools, employment of members at companies, following of a member or company by another member, business relationships and/or partnerships between organizations, and/or residence of members at locations.

Jobs data 218 may include structured and/or unstructured data for job listings and/or job descriptions that are posted and/or provided by members of the social network. For example, jobs data 218 for a given job or job listing may include a declared or inferred title, company, required or desired skills, responsibilities, qualifications, role, location, industry, seniority, salary range, benefits, and/or member segment.

Profile data 216 and/or jobs data 218 may further include job histories of members of the social network. Each job history may include a chronological sequence of jobs for a given member that terminates in the member's current job and/or the member's most recently listed job. As a result, the job history may be assembled from current and/or previous jobs listed in the member's current profile data 216. The job history may also, or instead, be supplemented with job listings, job descriptions, and/or other information in jobs data 218. For example, a job listing that is posted in the social network may be matched to a member that applies for and subsequently accepts an offer for the corresponding job. In turn, the job in the member's job history may be populated and/or associated with skills, benefits, qualifications, requirements, salary information, and/or other information from the job listing.

In one or more embodiments, attribute repository 234 stores data that represents standardized, organized, and/or classified attributes in profile data 216 and/or jobs data 218. For example, skills in profile data 216 and/or jobs data 218 may be organized into a hierarchical taxonomy that is stored in attribute repository 234 and/or another repository. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in attribute repository 234 may include cities, metropolitan areas, states, countries, continents, and/or other standardized geographical regions. In a third example, attribute repository 234 includes standardized company names for a set of known and/or verified companies associated with the members and/or jobs. In a fourth example, attribute repository 234 includes standardized titles, seniorities, and/or industries for various jobs, members, and/or companies in the social network. In a fifth example, attribute repository 234 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.).

An analysis apparatus 204 uses job histories of the members generated from profile data 216 and/or jobs data 218 to generate a knowledge graph 214. Within knowledge graph 214, nodes 226 and edges 228 may store standardized versions of attributes (e.g., attribute 1 222, attribute x 224) in profile data 216 and job data 218. As a result, analysis apparatus 204 may use the taxonomy stored in attribute repository 234 to convert job titles, industries, seniorities, companies, schools, locations, and/or other attributes in profile data 216 and/or jobs data 218 into standardized versions of the attributes.

Next, analysis apparatus 204 may populate nodes 226 in knowledge graph 214 with positions of the members in the job histories. Analysis apparatus 204 may also connect pairs of nodes 226 in knowledge graph 214 with edges 228 representing transitions between the corresponding positions by the members. For example, analysis apparatus 204 may create a node for each position with a standardized job title from the members' job histories. Analysis apparatus 204 may then create directed edges 228 that link the node with other nodes representing other standardized job titles to represent all transitions between the standardized job title and the other standardized job titles in the members' job histories.

Analysis apparatus 204 may further include, in nodes 226 and edges 228 of knowledge graph 214, relevant attributes for the corresponding positions and transitions. For example, each node that is identified by a standardized job title may include additional standardized attributes such as an industry, seniority, company, school, and/or location associated with the corresponding position. The node may also include other attributes related to employment in the position, such as an average salary, bonus, equity compensation, and/or other type of compensation; an average number of hours worked per week, an average number of vacation days a year, and/or another measure of work-life balance; and/or benefits such as insurance, retirement account contributions, subsidized healthcare, education, gym memberships, and/or free or reduced-cost transportation. The node may further include social impact features such as a reputation score and/or a representation of the member's connections in the social network while the member holds the position (e.g., the average job title from strong connections of the member, etc.).

In another example, each edge may be identified by a source node representing a starting position associated with the corresponding transition and a destination node representing an ending position associated with the transition. The edge may include attributes such as an average length of the transition (e.g., the average number of years required to transition from the starting position to the ending position), an average salary increase associated with the transition, and/or a likelihood of making the transition (e.g., the proportion of members that transition to the ending position out of all members that have held the starting position).

Analysis apparatus 204 may periodically and/or continuously update knowledge graph 214 with new positions and/or transitions in job histories of the members. For example, analysis apparatus 204 may add new nodes 226 and edges 228 to reflect new positions, standardized titles, and/or transitions between pairs of positions in the job histories. Analysis apparatus 204 may also, or instead, update average salaries, transition times, transition likelihoods, and/or other attributes or metrics associated with nodes 226 and edges 228 to reflect the most recent changes to profile data 216 and/or jobs data 218.

After knowledge graph 214 is created and/or updated, a management apparatus 206 uses knowledge graph 214 to process career path queries 208 involving the members. Each career path query may identify one or more members and include parameters such as a target position, one or more objectives, and/or one or more constraints.

For example, management apparatus 206 may obtain and/or identify one or more career objectives for a member. The career objectives may be explicitly specified by the member (e.g., in the member's answers to career-related questions) or inferred from the member's behavior (e.g., job searches, browsing behavior, interaction with other members, etc.). As a result, the career objectives may represent career-related goals and/or priorities of the member, such as one or more positions the member wishes to attain, an increase in salary, seniority, prestige, visibility, and/or lifetime earnings; an improvement in work-life balance or benefits; a reduction in commute time or cost of living; a maximum number of years spent in full-time employment; and/or a change in career path or industry.

In turn, career objectives for a member may be used as parameters of a career path query for the member. After management apparatus 206 receives the career path query, management apparatus 206 searches knowledge graph 214 for paths that meet the parameters of the career path query. Continuing with the previous example, management apparatus 206 may search some or all of knowledge graph 214 for paths starting at the member's current position that meet the member's stated or inferred career objectives.

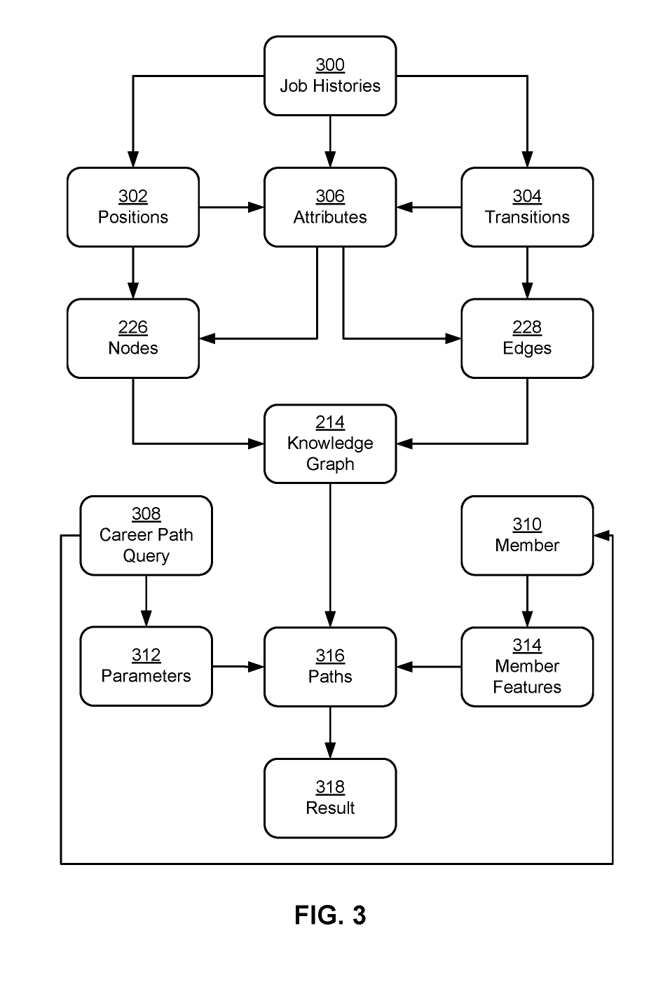

Management apparatus 206 includes, in results 210, paths that best match the parameters of career path queries 208. Management apparatus 206 then returns results 210 in response to career path queries 208. For example, management apparatus 206 may select paths that balance the member's career objectives with the average time required to attain those objectives, the number of transitions in the paths, the likelihood of attaining those objectives along those paths, and/or other considerations. Management apparatus 206 may then generate a result that includes the selected paths and output the result to the member (e.g., in an email, message, notification, recommendation, and/or other communication). Using knowledge graphs to process career path queries is described in further detail below with respect to FIG. 3.

By using knowledge graph 214 to identify career path transitions that meet the career objectives and/or targets of individual members, the system of FIG. 2 leverages social networks and profile data in social networks to provide insights that facilitate career advancement for members of the social network. For example, the system may recommend positions for advancing the members' careers along career paths that help fulfill the members' career goals, job postings for the positions, and/or actions for attaining the positions (e.g., developing skills, attaining experience, attending courses, etc.). In turn, the system may increase the value of the social network to the members, the value provided by the members to the social network, and/or member engagement with the social network. Consequently, the system may improve technologies related to online social networks and/or leveraging skills-based insights through network-enabled devices and/or applications, as well as user engagement and interaction through the social networks, network-enabled devices, technologies, and/or applications.

Those skilled in the art will appreciate that the system of FIG. 2 may be implemented in a variety of ways. First, analysis apparatus 204, management apparatus 206, data repository 134, and/or attribute repository 234 may be provided by a single physical machine, multiple computer systems, one or more virtual machines, a grid, one or more databases, one or more file systems, and/or a cloud computing system. Analysis apparatus 204 and management apparatus 206 may additionally be implemented together and/or separately by one or more hardware and/or software components and/or layers.

Second, a number of techniques may be used to identify paths in knowledge graph 214 that parameters of career path queries 208. For example, paths from a member's current position to a target position may be sorted, filtered, and/or optimized for shortness (e.g., number of hops, average duration, etc.), likelihood of attainment, work-life balance, benefits, location, and/or other factors. In another example, various optimization and/or constraint-satisfaction techniques may be used to search knowledge graph 214 for some or all paths that match multiple objectives and/or constraints associated with a member's career path query.

Third, profile data 216, jobs data 218, knowledge graph 214, and/or other data 202 used to generate results 210 of career path queries 208 may be obtained from a variety of sources. As mentioned above, the data may be obtained and/or tracked within a social network and/or other community of users. Alternatively, some or all of the data may be obtained from other applications, user interactions, and/or public records.

FIG. 3 shows the use of knowledge graph 214 to process a career path query in accordance with the disclosed embodiments. As mentioned above, knowledge graph 214 may be generated from job histories 300 of members of a social network, online community, and/or other population of users. As a result, knowledge graph 214 may model the career paths of the members.

Job histories 300 may be obtained from profile data, records of user activity, public records, and/or other sources of employment data for the members. Job histories 300 include positions 302 held by the members and transitions 304 between pairs of positions 302 by the members. In turn, attributes 306 of positions 302 and transitions 304 in job histories 300 are used to populate nodes 226 and edges 228 of knowledge graph 214.

For example, each node in knowledge graph 214 may be identified by a standardized title for the corresponding position. The position may include a job, fellowship, enrollment at a school, volunteer position, group membership, leadership position, and/or another type of role occupied by one or more members. The node may also store and/or be associated with additional attributes 306 of the position, such as a seniority, average salary, reputation score, location, company, industry, common or required skills, common or required education, common or required work experience, and/or average tenure (e.g., average number of years of employment at the position).

Similarly, each edge in knowledge graph 214 may be a directed edge representing a transition from a starting position to an ending position by one or more members. As a result, edges 228 may be formed between consecutive positions 302 of the members in job histories 300. Each edge may further be augmented with attributes 306 of the corresponding transition, such as an average change in salary, an average number of years required to make the transition, and/or a likelihood of the transition (e.g., the number of members that have made the transition divided by the total number of members that have occupied the starting position).

After knowledge graph 214 is generated, knowledge graph 214 is used to identify paths 316 that match a career path query 308. As shown in FIG. 3, career path query 308 may pertain to a specific member 310. Consequently, career path query 308 may be processed using parameters 312 of career path query 308 and member features 314 of member 310.

For example, an identifier for member 310 may be included in career path query 308 and/or parameters 312 of career path query 308. The identifier may be used to retrieve additional member features 314 of member 310, including a current position, previous positions, educational background, volunteer experience, skills, industry, location, and/or other member attributes relevant to processing of career path query 308.

Member features 314 are then used to identify one or more starting nodes in knowledge graph 214 for use in processing career path query 308, and knowledge graph 214 may be searched for paths 316 from the starting nodes that satisfy other parameters 312 of career path query 308. Some or all paths 316 that match parameters 312 may then be included and/or outputted in a result 318 of career path query 308.

In one or more embodiments, career path query 308 is processed based on the types and numbers of parameters 312 in career path query 308. First, parameters 312 of career path query 308 may include a target position and a single objective. As a result, knowledge graph 214 may be searched for paths 316 from a node representing the member's current position to one or more nodes representing the target position. Paths 316 may then be ordered and/or filtered in result 318 according to the specified objective.

For example, career path query 308 may include a target position with a title of “Chief Technology Officer” and an objective of reaching the target position in the least amount of time. The member's current position may be matched to a node in knowledge graph 214 that includes the title, seniority, location, company, company size, industry, and/or other member features 314 associated with the current position. Similarly, the target position may be matched to one or more nodes with the title and/or other attributes that are relevant to career path query 308 and/or member features 314 (e.g., location, industry, company, company size, etc.). The cost of each edge in knowledge graph 214 may also be represented as the average number of years required to transition from a starting position to an ending position. A shortest path search technique may then be used to identify one or more paths 316 in knowledge graph 214 that connect the member's current position and the target position in the shortest average amount of time.

In another example, career path query 308 may include the same target position and an objective of reaching the target position along the easiest or most likely career path. Knowledge graph 214 may thus be searched for some or all paths 316 from the member's current position to the target position. Edges 228 between nodes 226 in each path may further be associated with a probability or likelihood of making the corresponding transition. Continuing with the example, an edge representing a transition from a starting position to an ending position may have a probability that is calculated by dividing the number of members that have made the transition over a time period (e.g., a number of years) by the total number of members that have occupied the starting position over the same period. Each transition may further be assumed to have a Markov property, and a path from the member's current position to the target position is represented as a Markov chain. As a result, the easiest or most likely path from the member's current position to the target position may have edges 228 that produce the highest combined probability between the current position and the target position. The easiest or most likely path may also, or instead, be identified by minimizing the sum of the negative logarithms of the probabilities of all edges 228 within the path.

Second, parameters 312 of career path query 308 may include a target position and multiple objectives. To generate result 318, a set of weights may be combined with the multiple objectives to identify one or more paths 316 between the member's current position and the target position that best match parameters 312.

For example, career path query 308 may include a target position of “Chief Technology Officer,” a first objective of increasing the ease or likelihood of attaining the target position, and a second, equally important objective of reducing the amount of time required to reach the target position. The two objectives may be assigned the same weight (e.g., 0.5), and each edge in paths 316 between nodes 226 representing the member's current position and the target position may include a first value representing the probability of making the corresponding transition and a second value representing the average amount of time required to make the transition. In turn, a score for each path may be calculated as a linear combination that includes 0.5 multiplied by a value that is inversely proportional to the average amount of time associated with all transitions represented by edges 228 in the path, which is then summed with 0.5 multiplied by the overall probability of reaching the target position along the path. One or more paths 316 with the highest scores may then be included in result 318.

On the other hand, the two objectives of likelihood of attaining the target position and time required to reach the target position may have different weights (e.g., 0.3 and 0.7 instead of 0.5 for both) if the member has explicit or inferred preferences for valuing one objective over another. As a result, paths 316 from the member's current position to the target position may be scored using the weights to better reflect the member's preferences.

Third, parameters 312 of career path query 308 may include multiple objectives with constraints instead of a specific target position. For example, career path query 308 may include objectives of increasing seniority, lifetime earnings, and/or work-life balance and a set of weights representing the relative importance of each objective. Career path query 308 may also include constraints such as a limit to the average number of years required to reach a final position in a career path, a maximum number of transitions between the member's current position and the final position, a minimum average annual salary associated with the final position, and/or a maximum average number of hours worked per week.

When career path query 308 lacks a target position, the search space of career path query 308 may be significantly larger than in the other two forms of career path query 308 that specify a target position. In this case, result 318 may be generated by searching a subset of knowledge graph 214 for paths 316 that best meet the objectives and satisfy the constraints. For example, a Monte Carlo tree search and/or other optimization or constraint-solving technique may be used to identify, from a larger set of paths 316 that start at the member's current position, one or more paths 316 that best match the combination of objectives and constraints.

After result 318 is generated, result 318 may be displayed within a homepage, news feed, search module, profile module, and/or other part of an online network. Result 318 may also, or instead, be delivered via email, a messaging service, one or more notifications, and/or another mechanism for communicating or interacting with the member. Result 318 may further be accompanied by additional information to facilitate carrying out of the corresponding transitions 304. For example, a path that is recommended to the member may be outputted with suggestions or advice for advancing along the path, such as skills, education, and/or work experience required to move to subsequent jobs in the path; companies, recruiters, and/or job listings that can be leveraged to transition to each job in the path; an introduction or recommendation to connect with other members that have recently made one or more of the same transitions 308; and/or courses or materials for learning skills or acquiring experience required to move to each position in the path. Consequently, result 318 and/or additional information associated with attaining result 318 may provide guidance and/or insights for developing the member's career and/or reaching the member's career goals.

The member's response to result 318 and/or accompanying information may further be tracked and used to update knowledge graph 214 and/or the processing of subsequent career path queries using knowledge graph 214. For example, subsequent transitions 304 between positions 302 by the member may be tracked and used to update the corresponding nodes 226 and/or edges 228 of knowledge graph 214. The member's transitions 304 may further be used to determine the frequency with which paths 316 recommended to the members are followed and/or help fulfill the members' career goals or objectives. In turn, metrics or statistics associated with nodes 226 and/or edges 228 in knowledge graph 214 (e.g., transition times, transition likelihoods, average salaries, average work-life balance, etc.) may be updated to reflect the subsequent transitions 304 and used to improve the accuracy or relevance of results for subsequent career path queries.

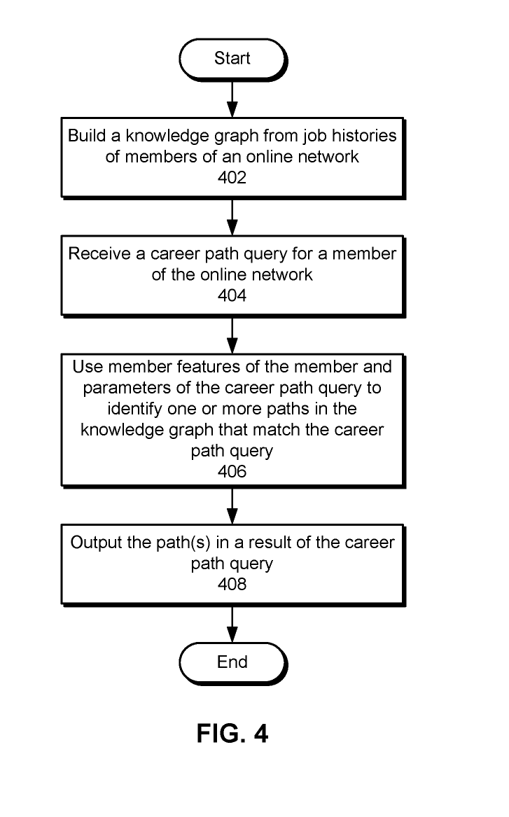

FIG. 4 shows a flowchart illustrating the processing of data in accordance with the disclosed embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a knowledge graph is built from job histories of members of an online network (operation 402). For example, titles, industries seniorities, companies, schools, locations, and/or other attributes of positions in the job histories may be standardized. The positions may then be stored in nodes of the knowledge graph, and transitions of the members between pairs of consecutive positions may be stored in edges of the knowledge graph.

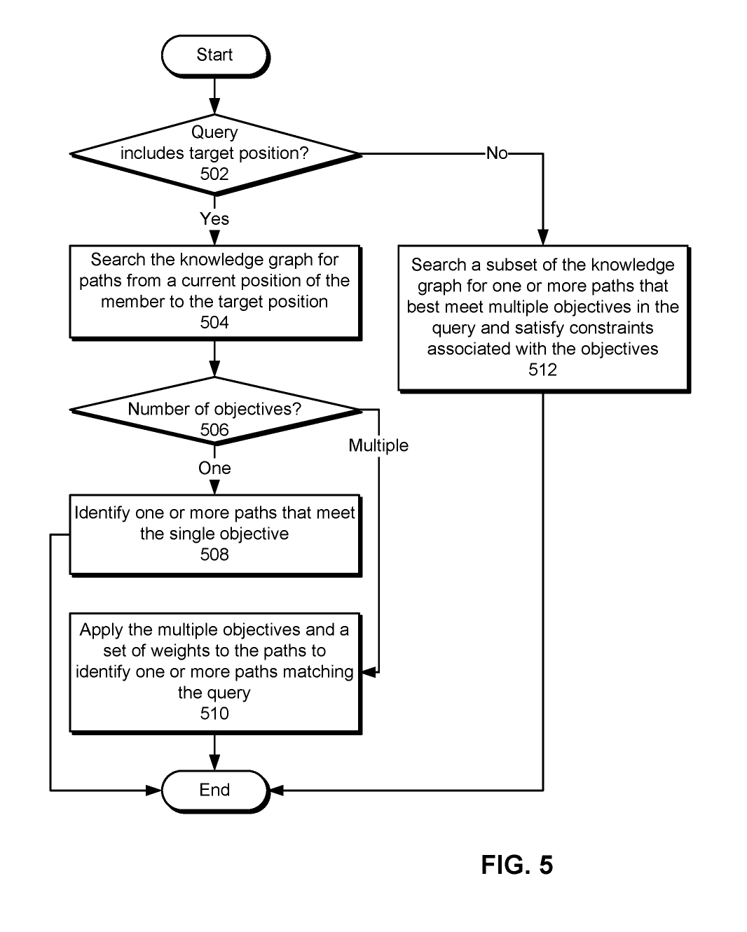

Next, a career path query for a member of the online network is received (operation 404). The career path query may be received from the member and/or generated in response to input from the member (e.g., job search behavior, browsing behavior, etc.). As a result, the career path query may include parameters that represent the member's career objectives and/or constraints associated with the career objectives. Member features of the member and parameters of the career path query are then used to identify one or more paths in the knowledge graph that match the career path query (operation 406), as described in further detail below with respect to FIG. 5.

Finally, the path(s) are outputted in a result of the career path query (operation 408). For example, one or more paths for attaining the member's career goals may be outputted in recommendations, notifications, emails, messages, user-interface elements, and/or other mechanisms for communicating with the member. The output may also include mechanisms for identifying, searching for, and/or reaching out to other members who have successfully completed the paths; job listings, companies, recruiters, and/or other resources that can be used to transition to subsequent positions along the paths; and/or recommendations for developing skills or experience required to make the transitions.

FIG. 5 shows a flowchart illustrating a process of generating a result of a career path query in accordance with the disclosed embodiments. In one or more embodiments, one or more of the steps may be omitted, repeated, and/or performed in a different order. Accordingly, the specific arrangement of steps shown in FIG. 5 should not be construed as limiting the scope of the embodiments.

The career path query may be processed based on the presence of a target position (operation 502) in parameters of the career path query. If the query does not include a target position, a subset of the knowledge graph is searched for one or more paths that best meet multiple objectives in the query and satisfy constraints associated with the objectives (operation 512). For example, a Monte Carlo tree search, optimization technique, and/or constraint-solving technique may be used to search a subset of the knowledge graph for one or more paths that maximize the objectives and satisfy the constraints.

If the query includes a target position, the knowledge graph is searched for paths from a current position of the member to the target position (operation 504). For example, one or more graph search techniques may be used to identify a certain number of shortest paths between the current position to the target position and/or a set of paths of up to a certain length between the current position and the target position.

After the paths between the current position and target position are identified, the query is processed based on the number of objectives (operation 506) specified in the parameters. If the query includes a single objective, one or more paths that meet the single objective are identified (operation 508) and returned in a result of the query. For example, the paths may be ordered according to an objective such as average time, lifetime earnings, likelihood, and/or work-life balance, and one or more paths that best meet the objective may be selected for inclusion in the result.

If the query includes multiple objectives, the multiple objectives and a set of weights are applied to the paths to identify one or more paths matching the query (operation 510). For example, the weights may reflect the relative importance of the corresponding objectives. As a result, the weights may be applied to measures of the corresponding objectives to generate a score for each path, and a subset of paths with the highest scores may be included in the result.

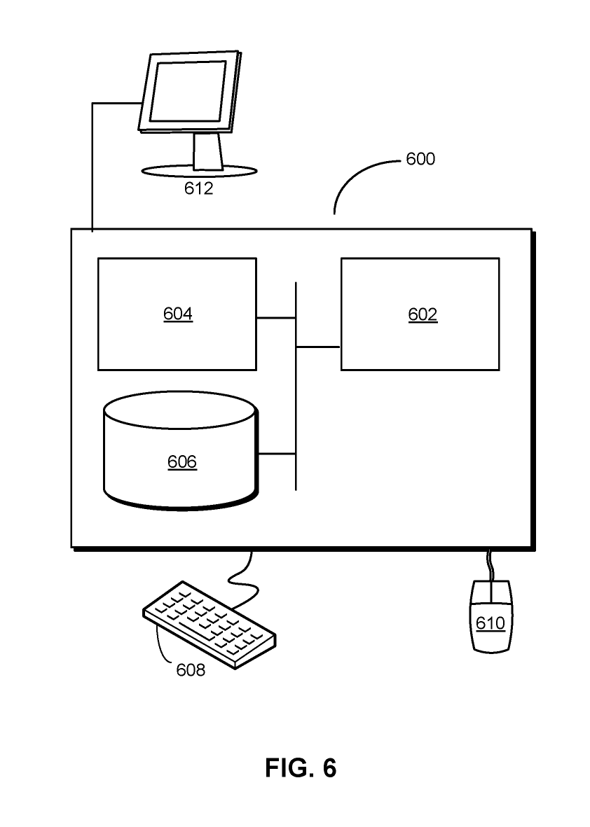

FIG. 6 shows a computer system 600 in accordance with the disclosed embodiments. Computer system 600 includes a processor 602, memory 604, storage 606, and/or other components found in electronic computing devices. Processor 602 may support parallel processing and/or multi-threaded operation with other processors in computer system 600. Computer system 600 may also include input/output (I/O) devices such as a keyboard 608, a mouse 610, and a display 612.

Computer system 600 may include functionality to execute various components of the present embodiments. In particular, computer system 600 may include an operating system (not shown) that coordinates the use of hardware and software resources on computer system 600, as well as one or more applications that perform specialized tasks for the user. To perform tasks for the user, applications may obtain the use of hardware resources on computer system 600 from the operating system, as well as interact with the user through a hardware and/or software framework provided by the operating system.

In one or more embodiments, computer system 600 provides a system for processing data. The system includes an analysis apparatus and a management apparatus, one or both of which may alternatively be termed or implemented as a module, mechanism, or other type of system component. The analysis apparatus obtains a knowledge graph containing a set of job transitions for members of an online network and receives a career path query for a member of the online network. The analysis apparatus also uses member features for the member and parameters of the career path query to identify one or more paths in the knowledge graph that match the career path query. The management apparatus then outputs the path(s) in a result of the career path query.

In addition, one or more components of computer system 600 may be remotely located and connected to the other components over a network. Portions of the present embodiments (e.g., analysis apparatus, management apparatus, data repository, attribute repository, online professional network, etc.) may also be located on different nodes of a distributed system that implements the embodiments. For example, the present embodiments may be implemented using a cloud computing system that recommends job and/or career path transitions for advancing the careers of a set of remote members of an online network.

By configuring privacy controls or settings as they desire, members of a social network, online professional network, or other user community that may use or interact with embodiments described herein can control or restrict the information that is collected from them, the information that is provided to them, their interactions with such information and with other members, and/or how such information is used implementation of these embodiments is not intended to supersede or interfere with the members' privacy settings.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
obtaining a knowledge graph that models career paths of a set of members of an online network;
receiving a career path query for a member of the online network;
using member features for the member and parameters of the career path query to identify, by a computer system, one or more paths in the knowledge graph that match the career path query; and
outputting the one or more paths in a result of the career path query.

2. The method of claim 1, further comprising:
building the knowledge graph from job histories of the members.

3. The method of claim 2, wherein building the knowledge graph from the job histories of the members comprises:
storing, in nodes of the knowledge graph, positions of the members from the job histories; and
storing, in edges of the knowledge graph, transitions of the members between pairs of the positions.

4. The method of claim 3, wherein building the knowledge graph from the job histories of the members further comprises:
standardizing one or more attributes of the positions and the transitions prior to storing the positions and the transitions in the knowledge graph.

5. The method of claim 4, wherein the one or more attributes comprise at least one of:
a title;
an industry;
a seniority;
a company;
a school; and
a location.

6. The method of claim 1, wherein the parameters of the career path query comprise a target position and a single objective.

7. The method of claim 6, wherein using the member features and the parameters to identify the one or more paths in the knowledge graph that match the career path query comprises:
searching the knowledge graph for a set of paths from a current position of the member to the target position; and
identifying, from the set of paths, the one or more paths that meet the single objective.

8. The method of claim 1, wherein the parameters of the career path query comprise a target position and multiple objectives.

9. The method of claim 8, wherein using the member features and the parameters to identify the one or more paths in the knowledge graph that match the career path query comprises:
searching the knowledge graph for a set of paths from a current position of the member to the target position; and
applying, to the set of paths, the multiple objectives and a set of weights to identify the one or more paths.

10. The method of claim 1, wherein the parameters of the career path query comprise multiple objectives with constraints.

11. The method of claim 10, wherein using the member features and the parameters to identify the one or more paths in the knowledge graph that match the career path query comprises:
searching a subset of the knowledge graph for the one or more paths that best meet the multiple objectives and satisfy the constraints.

12. The method of claim 1, wherein the knowledge graph further comprises a set of attributes associated with the career paths.

13. The method of claim 1, wherein the set of attributes comprises:
an average salary of a position;
a work-life balance of the position;
a job benefit associated with the position;
an average length of a transition between two positions;
an average salary increase associated with the transition; and
a likelihood of the transition.

14. A system, comprising:
one or more processors; and
memory storing instructions that, when executed by the one or more processors, cause the system to:
obtain a knowledge graph that models career paths of a set of members of an online network;
receive a career path query for a member of the online network;
use member features for the member and parameters of the career path query to identify one or more paths in the knowledge graph that match the career path query; and
output the one or more paths in a result of the career path query.

15. The system of claim 14, wherein the memory further stores instructions that, when executed by the one or more processors, cause the system to:
build the knowledge graph from job histories of the members.

16. The system of claim 15, wherein building the knowledge graph from the job histories of the members comprises:
storing, in nodes of the knowledge graph, positions of the members from the job histories; and
storing, in edges of the knowledge graph, transitions of the members between pairs of the positions.

17. The system of claim 14, wherein the parameters of the career path query comprise at least one of:
a target position and a single objective;
the target position and a first set of objectives; and
a second set of objectives with constraints.

18. The system of claim 14, wherein the knowledge graph further comprises a set of attributes associated with the career paths.

19. The system of claim 18, wherein the set of attributes comprises:
a title of a position;
an average salary of the position;
a work-life balance of the position;
a job benefit associated with the position;
an average length of a transition between two positions;
an average salary increase associated with the transition; and
a likelihood of the transition.

20. A non-transitory computer-readable storage medium storing instructions that when executed by a computer cause the computer to perform a method, the method comprising:
obtaining a knowledge graph that models career paths of a set of members of an online network;
receiving a career path query for a member of the online network;
using member features for the member and parameters of the career path query to identify one or more paths in the knowledge graph that match the career path query; and
outputting the one or more paths in a result of the career path query.
